(19) United States
(12) Patent Application Publication
(10) Pub. No.: US 2008/0216524 A1
(43) Pub. Date: Sep. 11, 2008

(54) Locking device and method for securing cargo containers during transport and storage that permits secure inspection of any authority seal

(75) Inventor: Amr Abdelhameed Abdelazeem, Killeen, TX (US)

Correspondence Address: WINSTEAD PC, P.O. BOX 50784, DALLAS, TX, 75201, US

(73) Assignee: Amr A. Abelazeem, Killeen, TX (US)

(21) Appl. No.: 11/713,986

(22) Filed: Mar. 5, 2007

(51) Int. Cl. E05B 65/48; E05B 65/14

(52) U.S. Cl. 70/13; 70/91

(57) ABSTRACT

A locking device for securing the doors of a tractor trailer or other cargo container during storage or transport where the locking device is mounted over the latching mechanism of the closing bar movably mounted on the doors of the trailer or container. The locking device includes an enclosure having an outward facing or front panel, side panels, a top panel with two holes formed therein, a partial back panel, and a back side partially open for mounting over the closing bar latching mechanism. The locking device also includes a tubular lock body securely attached to the interior of the partial back panel of the enclosure, and a U-shaped latch rod for inserting through the holes in the top panel of the enclosure into the lock body within the enclosure following the positioning of the enclosure over the latching mechanism of the closing bar. Once the enclosure is mounted and securely held in place by the insertion of the latch rod into the lock body, the operator then uses a key to lock the locking device in a locked position protecting the latching mechanism. Following installation, the locking device not only securely locks the doors of the container/trailer but also protects any authority seal placed over the locking mechanism to prevent theft or tampering. The front panel of the locking device also has a centrally located opening formed therein which permits the transporter or an inspection authority to inspect quickly and easily the sealed locking mechanism to insure that the seal has not been broken or subjected to tampering.

### TECHNICAL FIELD

The present invention relates generally to the field of locking devices and methods for securing cargo containers during storage or transportation, and more particularly to a locking device and method for locking the doors of a tractor trailer or other cargo container which protects the security or authority seal associated with the locking device while permitting the seal to be visually inspected by the transporter and security authorities.

### BACKGROUND OF THE INVENTION

In the past there have been numerous and diverse special purpose locks and lock guards that have been developed to secure the doors to cargo containers such as tractor trailers and portable cargo containers. For example, the door locking system exemplified by U.S. Pat. No. 4,269,048 was specifically designed to lock the rear doors of the cargo trailer of a tractor-trailer rig. Such locking system included a locking bar fixedly secured to one door and attachably secured to the second door. A pin projected from the second door so that the pin could pass through an opening in the locking bar. A pin cover locks over the pin for securing the bar to the second door. In U.S. Pat. No. 5,062,669, a lock mechanism is disclosed for locking the doors to a tractor-trailer vehicle which includes a reciprocal or rotatable locking member, such as a sliding bolt, movable up through the floor of the trailer to a first locking position wherein a door is positively locked and released by connection with the air system of the vehicle. U.S. Pat. No. 6,702,310 B2 discloses a tandem handle lock-out tool for use with a tractor trailer. The tandem handle lock-out tool may be formed of a flat bar stock with a bend therein or two pieces of bar stock maybe welded together.

It is also common to see trailer doors with conventional “closing bar” door latching systems that are secured only with a padlock. To further secure such latching systems, lock guards such as exemplified by U.S. Pat. No. 5,743,118 have been developed. The lock guard protects both the latching mechanism and the lock by covering the padlock and latching mechanism with a housing cover. U.S. Pat. No. 7,047,774 B1 discloses a security device which includes a removable locking pin structure that is manually removable through a housing chamber for a puck lock.

Such locks and lock guards did not contemplate the enhanced security needs and requirements following the terrorist attack on New York City on Sep. 11, 2001. Because of these increased security concerns and new governmental regulations and guidance criteria resulting from such security concerns, homeland security authorities, tractor trailer truck owners, container shipping companies and insurance companies have a need for a new type of locking system to secure cargo containers during both storage and transport. Given the high rate of crime and the need for enhanced homeland security, prior locking mechanisms and lock guards are lacking is that a single crook or terrorist with a snap cutter can cut the conventional locking device in a matter of seconds.

As a major element of the Department of Homeland Security, the Bureau of Customs and Border Protection (“BCBP”) has taken major initiatives in this area. As a result of recent laws and regulations that impose new detailed 24 hour advance reporting requirements for inbound and outbound cargo shipments, BCBP has instituted supply chain security programs such as the Customs-Trade Partnership Against Terrorism (“C-TPAT”) program. Although this is a voluntary supply chain security program, if a company does not participate in this program, it is at a major competitive disadvantage. Effective Mar. 13, 2006, BCBP's new Highway Carrier Minimum Security Criteria became part of the C-TPAT program. Accordingly, when transporting a container or trailer for a C-TPAT importer, a high security seal that meets or exceeds the current PAS ISO 17712 standard for high security seals must be utilized. Further, new shipping company rules and regulations require that that certain cargo systems be sealed. Currently available lock systems for trailers and containers do NOT protect such seals. Therefore a new more secure locking system for such tractor trailers is needed that enables shippers, drivers and homeland security officials to check and read the seal number on the security seal and to assure that the doors of the cargo trailer or container has not been unlawfully opened or tampered with.

Accordingly, there is a need for a new locking device and method that protects both the locking mechanism and the seal, is more difficult to tamper with, and that also permits the sealed locking mechanism to be inspected. There is also a further need for such improved locking device and method to be simple to manufacture, easy to use, and relatively inexpensive.

### SUMMARY OF INVENTION

Briefly, the present invention provides a new and improved device and method for securely locking the doors of a tractor trailer or other cargo container during transport and/or storage which protects any security or authority seal associated with the locking device while permitting the seal to be visually inspected by security authorities. The trailer or container has a closing bar door latching system with a latching mechanism for latching the doors in a closed position The locking device includes an enclosure for placement over the latching mechanism wherein the enclosure has a front panel, a plurality of side panels, a top panel having at least two openings formed therein, a bottom panel, and a partial back panel opposite the front panel wherein the partial back panel is sized to create a partially open back side to the enclosure for mounting over the latching mechanism. The front panel has an opening formed therein of sufficient size to permit an inspection or receiving authority to inspect the door latching mechanism and any seal on the door latching mechanism. The locking device further includes a lock body securely attached to the interior of the partial back panel of the enclosure, a latch rod having two prongs for inserting through two openings in the top panel of the enclosure and into the lock body; and a key for locking the inserted latch rod into the lock body, whereby the enclosure may be positioned over the latching mechanism and securely locked into position by using the key to lock the latch rod into the lock body following its insertion through the holes in the top panel of the enclosure. The method for securely locking the doors of a tractor trailer or other cargo container during transport and storage relates to a trailer or container that has a closing bar door latching system with a rotating bar, latch handle, and a hinge system with a stationary portion and a pivotally mounted hinge portion wherein each hinge portion having an extension thereof with openings formed therein, for latching the doors in a closed position. The method includes positioning the enclosure over the latch handle and hinge system of the latching mechanism once the rotating bar, latch handle, and hinge system are in the closed position. The method further includes inserting the prongs of a generally U-shaped latch rod through openings in the enclosure and into a lock body attached to the interior of the enclosure, and locking the latch rod into the lock body, wherein the enclosure is locked into position about the latch handle and hinge system of the door latching system on the doors of the trailer or container. Preferably, the method includes sealing the closed hinge system with a seal prior to positioning the enclosure over the latch handle and hinge system and inspecting the seal through an opening in the enclosure, wherein the enclosure is locked about the sealed latching mechanism while permitting the seal to be viewed through an opening formed in the enclosure and thereby permit the sealed mechanism to be inspected regularly. Following installation, the locking device not only securely locks the doors of the trailer or container during transport or storage but also protects any security or authority seal on the locking mechanism. The security or authority seal can also be quickly and easily inspected to insure that the seal has not been broken or subjected to tampering.

### BRIEF DESCRIPTION OF DRAWINGS

For a more complete understanding of the present invention, and the advantages thereof, reference is now made to the following descriptions taken in conjunction with the accompanying drawings, in which:

FIG. 1 is a rear perspective view of the locking device and the doors of a container and tractor trailer on which the locking device may be used in accordance with an embodiment of the present invention;

FIG. 2A is an isometric view of the lock enclosure and phantom views of the U-shaped latch rod and tubular lock body of an embodiment of the locking device of the present invention;

FIG. 2B is an isometric view of the front of the lock enclosure of an embodiment of the locking device of the present invention;

FIG. 3 is a plan view of the U-shaped latch rod and tubular lock body of an embodiment of the locking device of the present invention; and

FIG. 4 is an isometric view of the locking device of the present invention positioned to fit over a conventional door latching mechanism on the back doors of a tractor trailer.

FIG. 5A is a plan view of the trailer/container door latching system, including the latching mechanism, when the doors are open.

FIG. 5B is a plan view of the trailer/container door latching system, including the latching mechanism, when the doors are closed and latched into the closed position.

FIG. 6A is an isometric view of the trailer/container door latching system when the doors are closing, together with an isometric view of the locking device of the present invention being placed around the latching mechanism.

FIG. 6B is a plan view of the locking device of the present invention surrounding the latching mechanism of the trailer/container door latching system when the doors are closed and latched into a closed position.

### DETAILED DESCRIPTION OF THE INVENTION

The principles of the present invention and their advantages are best understood by reference to the drawings. Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. It is therefore, contemplated that the claims will cover any such modifications or embodiments that fall within the true scope of the invention.

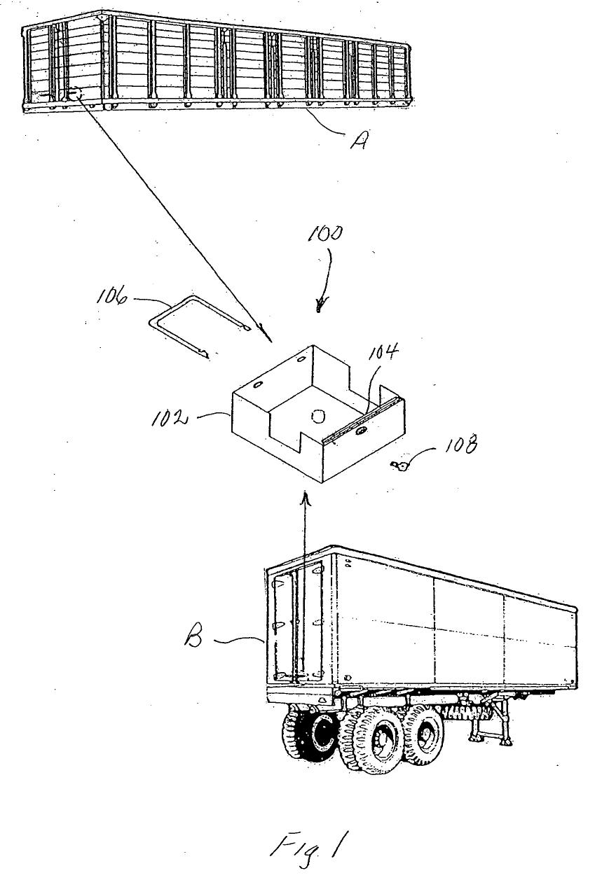

FIG. 1 illustrates a locking device 100 configured in accordance with an embodiment of the present invention that can be used to secure a cargo container during storage or transport. For example, the locking device 100 may be placed over the closing bar latching mechanism of a conventional door latching system commonly used to close the doors of a portable cargo container A, a tractor trailer vehicle B, or other types of units or containers used to store materials or transport cargo, as will be described in more detail hereinafter. The locking device 100 is of particular utility for storage trailers/container such as those found on general trucks, 18 wheel tractor trailer vehicles, 20 feet or 40 feet containers, and similar military/commercial vehicles or storage containers.

The locking device 100 includes an enclosure or housing 102 having one side open for mounting over the closing bar latching mechanism of the trailer/container. It also includes a tubular lock body 104 securely attached to the interior of the back “side” or “panel” of the enclosure 102 and a U-shaped latch rod 106 for inserting into the lock body 104 following the positioning of the enclosure 102 over the latching mechanism of the closing bar movably mounted on the rear doors of common cargo trailers/containers. Once the enclosure 102 is mounted and securely held in place by the insertion of the latch rod 106 into the lock body 104, the operator then uses a key 108 to lock the locking device 100 in a locked position. Following installation, the locking device 100 not only securely locks the doors of the container/trailer but also protects any security or authority seal over the locking mechanism to prevent theft or tampering. The locking device 100 therefore permits the transporter or an inspection authority to inspect quickly and easily the sealed locking mechanism to insure that the sealed locking mechanism has not been subjected to tampering. The locking device 100 is also simple to manufacture, easy to use, and relatively inexpensive.

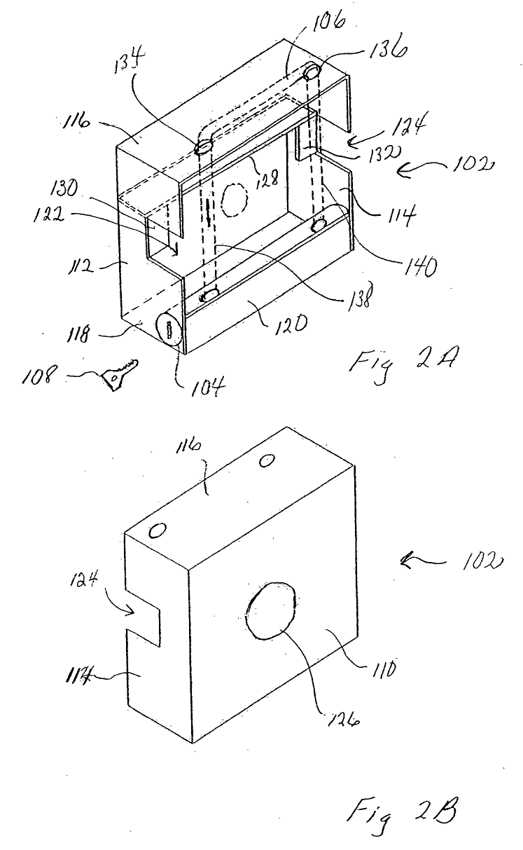

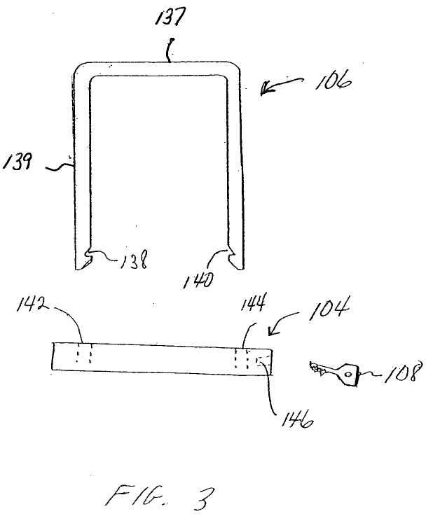

In FIG. 2A and 2B, the components of the locking device are shown in more detail. The enclosure 102 has an outward facing or “front” panel 110, two side panels 112 and 114, a top panel 116, a bottom panel 118, and a partial back panel 120 opposite the front panel 110, which extends a sufficient distance from the bottom panel 118 of the enclosure to permit the lock body 104 to be securely mounted into the enclosure 102 between the side panels by a variety of conventional means but not extending so far as to interfere with the insertion of the enclosure 102 over the closing bar of a conventional door latching system for latching the doors of a container in the closed position. Preferably, the lock body 104 is securely attached to the interior side of the partial back panel 120 by welding or other conventional means for attaching.

The side panels 112 and 114 have generally rectangularly-shaped openings 122 and 124, respectively, formed therein that extend from the opening in the back panel 120 sufficiently inward to permit the placement of the enclosure 102 over the closing bar so that the back panel fits up against the door of the cargo container. The front panel 110 also have a generally centrally located aperture or opening 126 formed therein. The opening 126 should be sufficiently large to permit an inspector to inspect the sealed locking mechanism holding the container doors closed, for example about 2 inches in diameter, but not large enough to permit a theft or terrorist to cut or otherwise force open the latching mechanism.

A partial interior panel 128 is mounted so that it extends inwardly from the front panel 110 a sufficient distance from the top panel 116 to secure the door latching mechanism from moving, as will be explained in more detail hereinafter, but not so far that it interferes with the placement of the enclosure over the closing bar of the door latching system. Two interior side panels 130 and 132 extend respectively from side panels 112 and 114 to strengthen the panel 128.

The top panel 116 have two apertures or openings 134 and 136 formed therein. The openings are sized to permit the two prongs 138 and 140 of the U-shaped latch rod 106 to be inserted through the openings so that they can be inserted into the lock body 104 for locking the enclosure into place about the locking mechanism on the door latching system of the container/trailer. Preferably, the enclosure 102 is made from steel sheets although other suitable materials such as aluminum or fiberglass may be used.

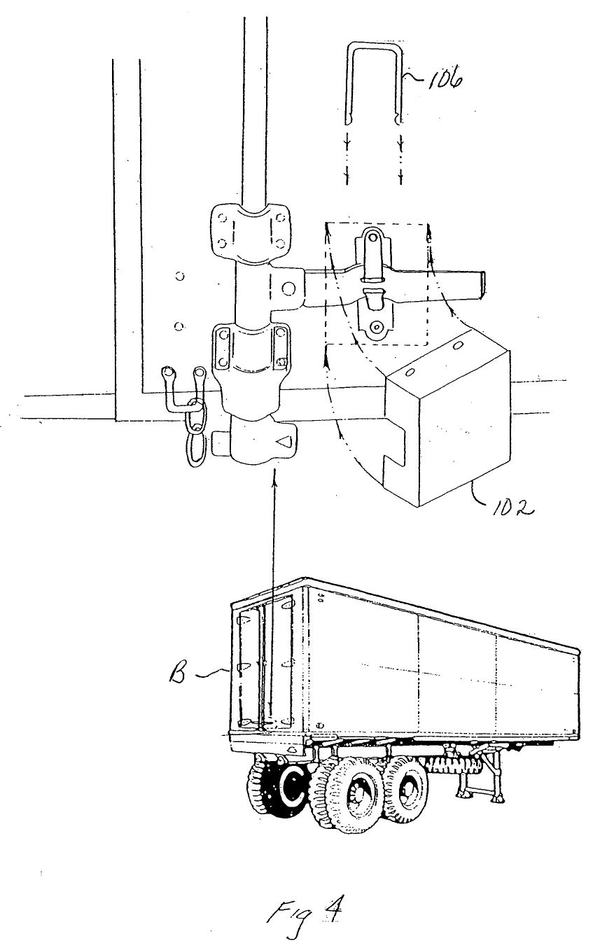

FIG. 3 shows the components of the U-shaped latch rod 106 and lock body 104 in more detail. The latch rod 106 has a base portion 137 and at least two prongs 139. Each of the prongs of the U-shaped latch rod 106 has grooves 138 and 140 formed therein for insertion into the lock body 104 as will be described in more detail hereinafter. The lock body 104 includes two holes 142 and 144 into which the prongs of the latch rod 106 can be inserted. The lock body 104 also has an opening formed in one end thereof into which is inserted a lock 146 of conventional design. Once the prongs of the latch rod 106 are inserted into the lock body 106, the key 108 may be used to lock the prongs of the latch rod into a secured lock position within the lock body 104. Preferably, each of the prongs 139 extend from the base portion 137 approximately at a 90 degree angle and have a length such that the base portion 137 of the latch rod fits snugly to the top panel of the enclosure following the insertion of the latch rod 106 through the openings in the top panel of the enclosure into the lock body 104. The rod 106 and lock body 104 are preferably made from high quality steel. The lock body is of conventional design and a suitable lock body may be obtained by purchasing a Knox Lock™ key-operated U-shaped lock and just use the lock body portion thereof. Alternatively, a person of ordinary skill in the art may manufacture a key-operated lock body of suitable strength. Alternatively, an electronic keyless lock body may be either purchased or manufactured. It should be noted that any method of locking the lock body is suitable and the term “key” as used herein shall include “keyless” and “electronic keyless” system for locking locks.

It should be noted that the dimensions of the various components of the locking device 100 are determined by the door latching system on which the device is intended to be used. For example, the dimensions of the enclosure 102 of the locking device 100 is for trailers on 18 wheel tractor trailer, 20 feet containers or 40 feet containers are approximately as follows: height 175 mm, length 210 mm and width 80 mm.

FIG. 4 shows in more detail how the locking device 100 is positioned over the latching mechanism of the closing bar commonly used to hold the doors of a tractor trailer in the closed position. After placing the U-shaped latch rod 106 through the enclosure 102, the key 108 is used to lock the U-shaped rod 106 into the lock body 104, which secures the enclosure over the latching mechanism of the closing bar as will be described in more detail hereinafter. The locking device thus surrounds the door latching mechanism without using any part of the latching mechanism.

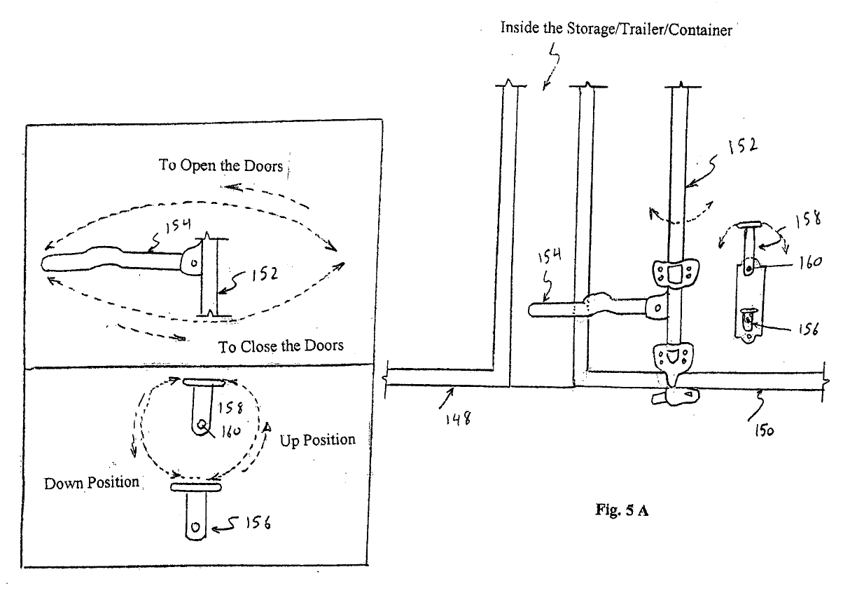

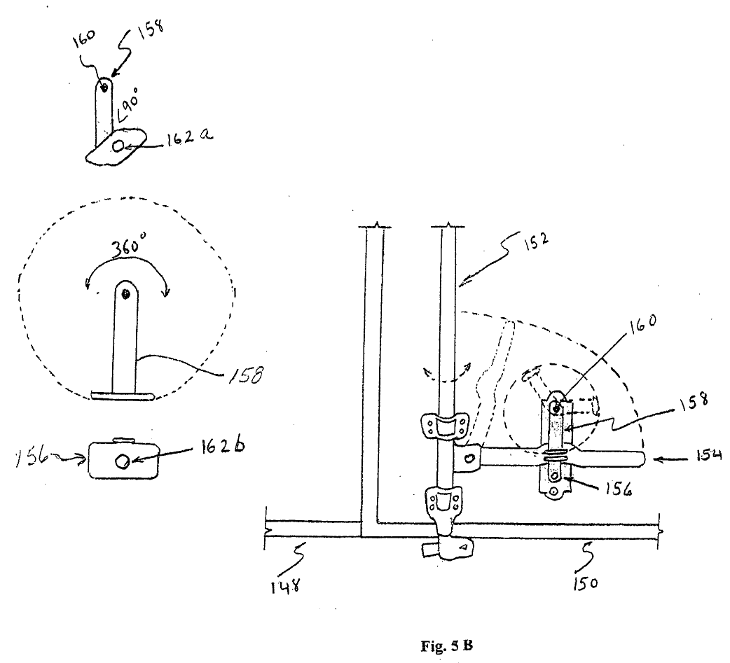

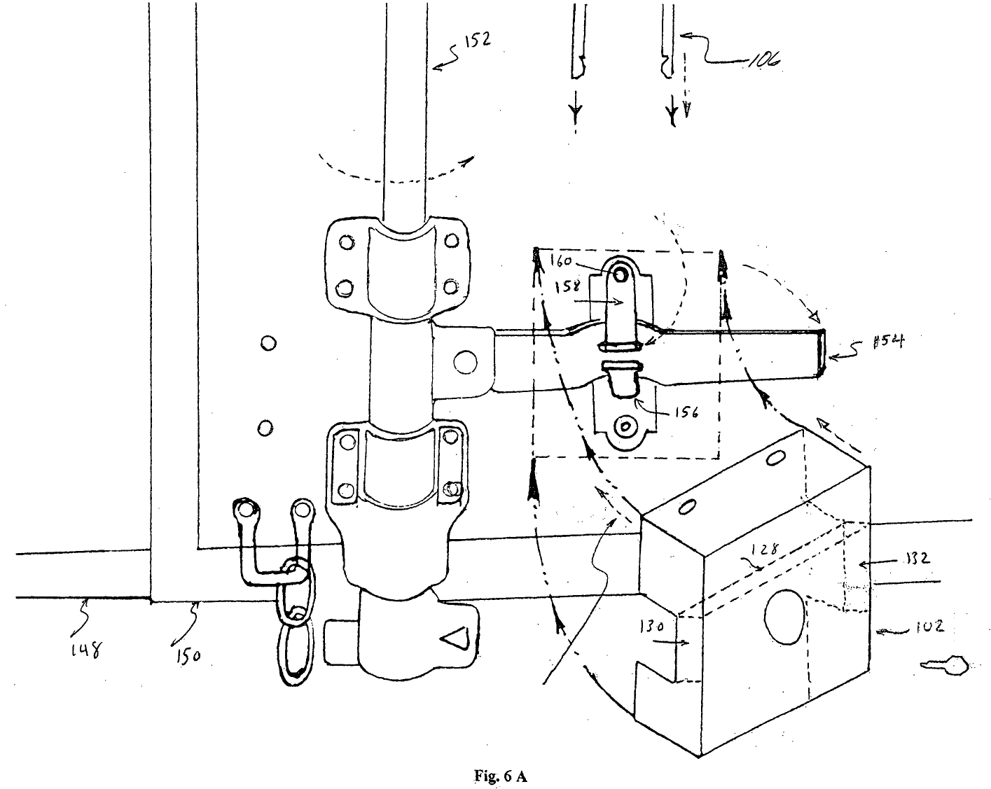

In FIG. 5A and 5B, the components of the door latching system on the trailer/container doors 148 and 150 are shown in more detail. In FIG. 5A, the trailer/container doors 148 and 150 are shown open such that there is an open space between the doors. In FIG. 5B, the door 148 is first closed and then door 150 is closed with a portion therefore holding door 148 in the closed position. To latch the doors in the closed position, steel bar 152 which rotates horizontally 180 degree, is rotated by an operator initially moving a latch handle 154 horizontally. The latch handle 154 is then rotated vertically into an open hinge system securely attached to the door 150 for securing the latch handle. The hinge system has a stationary portion 156 and a pivotally mounted hinge portion 158 mounted on a pin 160 such that the hinge can be rotated 360 degrees. Both the stationary portion 156 and the pivotally mounted hinge portion 158 also have an extension at the end thereof which extends outwardly from the door at a 90 degree angle which have an opening 162a and 162 b formed therein. In the past, to secure the latch handle in the closed position and thereby lock the steel bar 152 on the bottom portion of the trailer/container, the hinge portion 158 is rotated so that it is aligned with and abutting stationary portion 156 so that a regular padlock could be inserted through the holes 162a and 162b to lock the latch handle and rotating bar into the closed position. In the operation of the present invention, the padlock is not used and an authority seal may be inserted through the holes 162a and 162b after the stationary portion 156 and the pivotally mounted portion 158 is in the down or closed position.

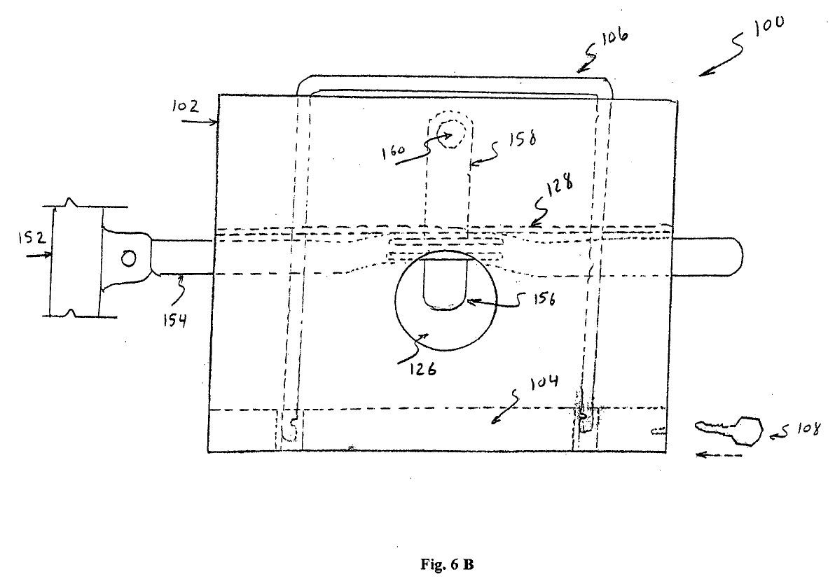

In FIG. 6A and 6B, the method of installing the locking device of the present invention on the trailer/container door latching system are shown in more detail. In step “a”: the steel bar 152 is rotated to its latched closed position. In step “b”, the latch handle 154 is rotated into its closed position. In step “c”, the pivotally mounted hinge portion 158 is rotated into the down position to align holes 162a and 162 b so that they are facing each other. In step “d”, the housing section 102 of the locking device 100 is placed over the latch handle 154 and hinge system parts 156, 158, 160 and 162a and 162b. In step “e” as shown in with more detail on FIG. 6B interior panel 128 must be placed above hinge portion 158 and the hole 162a therein to prevent the hinge portion 158 and the hole 162a from rotating out of the closed and latched position, thereby securing the door latching system positioning a closed and latched position. In step “f”, the person holding the enclosure 102 will use one hand to put a light pressure on the enclosure 102 and then with the second hand insert the prongs of the U-shaped latch rod 106 through the openings 134 and 136 in the top panel 116, into the holes 142 & 144 of the lock body 104. In step “g”: using either the key 108 or a keyless lock body, the latch rod is locked securely into the lock body 104, thereby securely locking the locking device over the latch mechanism of the door latching system and the authority seal. In step “h”, the security authority can view the authority seal on the latching mechanism through the front opening 126 of the locking device 100 to check the integrity of the authority seal. The device 100 is therefore quickly and efficiently put into place by one person. The trailer/container latching mechanism is thus securely locked in a closed position, and the mechanism and authority seal are protected from tampering, theft or terrorist acts while still being subject to inspection through the opening 126 in the front panel of the locking device.

Although the present invention and its advantages have been described in detail, it should be understood that various changes, substitutions and alterations can be made herein without departing for the spirit and scope of the invention as defined by the appended claims.

What is claimed is:

1. A locking device for securely locking the doors of a tractor trailer or other cargo container during transport and storage wherein the trailer or container has a closing bar door latching system for latching the doors in a closed position, comprising:
an enclosure for placement over the latching mechanism of a closing bar door latching system wherein the enclosure has a front panel, a plurality of side panels, a top panel having at least two openings formed therein, a bottom panel, and a partial back panel opposite the front panel wherein the partial back panel is sized to create a partially open back side to the enclosure for mounting over the latching mechanism, and wherein the front panel has an opening formed therein of sufficient size to permit an inspection or receiving authority to inspect the door latching mechanism and any seal on the door latching mechanism;
a lock body securely attached to the interior of the partial back panel of the enclosure;
a latch rod having two prongs for inserting through two openings in the top panel of the enclosure and into the lock body; and
a key for locking the inserted latch rod into the lock body, whereby the enclosure may be positioned over the latching mechanism and securely locked into position by using the key to lock the latch rod into the lock body following its insertion through the holes in the top panel of the enclosure.

2. The locking device of claim 1, wherein:
The side panels have generally rectangularly-shaped openings that extend from the opening in the back side of the enclosure inwardly to permit the placement of the enclosure over the closing bar latching mechanism.

3. The locking device of claim 2, wherein the enclosure further comprises:
a partial interior panel that extends inwardly from the front panel a sufficient distance from the top panel for securing the latching mechanism from moving.

4. The locking device of claim 3, wherein the enclosure further comprises:
a plurality of interior side panels to strengthen the partial interior panel.

5. The locking device of claim 1, wherein at least a portion of the enclosure is made of steel.

6. The locking device of claim 1, wherein at least a portion of the enclosure is made of fiberglass.

7. The locking device of claim 1, wherein the latch body is U-shaped and comprises a base portion and a plurality of prongs.

8. The locking device of claim 7, wherein each of the prongs extend from the base portion approximately at a 90 degree angle and have a length such that the base portion of the latch rod fits snugly to the top panel of the enclosure following the insertion of the latch rod through the openings in the top panel of the enclosure into the lock body.

9. The locking device of claim 7, wherein the latch body and lock body are made of steel.

10. The locking device of claim 1, wherein the key comprises a keyless locking system.

11. A method for securely locking the doors of a tractor trailer or other cargo container during transport and storage wherein the trailer or container has a closing bar door latching system with a latching mechanism that includes a rotating bar, latch handle, and hinge system with a stationary portion and a pivotally mounted hinge portion with an extension thereof with openings formed therein, for latching the doors in a closed position, comprising:
positioning the enclosure over the latch handle and hinge system of the latching mechanism once the rotating bar, latch handle, and hinge system are in the closed position;
inserting the prongs of a U-shaped latch rod through openings in the enclosure and into a lock body attached to the interior of the enclosure; and
locking the latch rod into the lock body, wherein the enclosure is locked into position about the latch handle and hinge system of the latching mechanism on the doors of the trailer or container.

12. The method of claim 11, wherein the step of positioning the enclosure further comprises:
placing an interior panel of the enclosure above the aligned openings in the hinge system to prevent the pivotable portion of the hinge system from rotating out of the closed and latched position.

13. The method of claim 11, further comprising:
sealing the closed hinge system with a seal prior to positioning the enclosure over the latch handle and hinge system.

14. The method of claim 13, further comprising the step of:
inspecting the seal through an opening in the enclosure.
